(19) United States
(12) Patent Application Publication
(10) Pub. No.: US 2007/0258023 A1
(43) Pub. Date: Nov. 8, 2007

(54) Dual-panel display panel, flat-panel display employing a dual-panel display panel, and method of showing images after the flat-panel display is turned off

(75) Inventors: Chao-Shih Huang, Taipei County (TW); Yung-Jen Lin, Taipei County (TW)

Correspondence Address: HARNESS, DICKEY & PIERCE, P.L.C., P.O. BOX 8910, RESTON, VA, 20195, US

(73) Assignee: Acer Incorporated

(21) Appl. No.: 11/429,052

(22) Filed: May 8, 2006

(51) Int. Cl. G02F 1/1347; G02F 1/1335

(52) U.S. Cl. 349/74; 349/15

(57) ABSTRACT

A dual-panel display panel includes a first display panel, and a second display panel located on the first display panel, wherein the second display panel includes a second lower plate having a plurality of thin-film transistors and a second upper plate having transparent electrodes, and a cholesteric liquid crystal layer formed between the second lower plate and the second upper plate.

### BACKGROUND OF THE INVENTION

1. Field of Invention

The present invention relates to a display panel, more specifically, to a dual-panel display panel and a flat-panel display employing the dual-panel display panel, and a method of displaying images after the flat-panel display is turned off.

2. Related Art

CRT(Cathode Ray Tube) has been widely used for TV screens, measuring devices and information terminals for a long time. However, the size and weight of CRT cannot meet with the increasing demand for lightweight and small-size displays. Therefore, small-size displays such as LCD (Liquid Crystal Display), PDP (Plasma Display Panel) and ELD (Electro-Luminescence Display) have been widely adopted to replace CRT.

At present, thin flat-panel displays have been applied to monitors of airplanes or spaceships, notebook computers, desktop computers, and large-size monitors. The demand for thin flat-panel displays has been on the increase.

Further, with an increasing demand for large-size TV's and the greater flexibility for home decoration that they provide, thin flat-panel displays have become a popular option for TV-buyers. However, as the thin flat-panel displays have become larger and larger, when the TV is turned off, the darkness of the display may not be compatible with the decoration of the house. Particularly, when a large-size wall TV is turned off, the large area of darkness may feel weird. Take LCD TV as an example, when the TV is turned off, the display loses the voltage that aligns the crystals. As a result, light cannot pass through the liquid crystal layer, thus the display becomes totally dark.

Therefore, a newly designed flat-panel display is expected to solve the problems described above.

### SUMMARY OF THE INVENTION

In order to solve the problems described above, the objectives of the present invention are to provide a dual-panel display panel, a flat-display panel employing the dual-panel display panel, and a method of showing images on the flat-panel display after the display is turned off., and to enable the user to select an image to be displayed on the flat-panel display after the display is turned off.

As described above, the flat-panel display may still show an image, which may be selected at will, after the display is turned off. The operation is power saving. A TV with the flat-panel display could also serve as a decorative piece that matches other decorations in the room instead of being just a TV.

In order to achieve the above objectives, the present invention provides a dual-panel display panel including a first display panel and a second display panel located on the first display panel, wherein the second display panel includes a second lower plate having a plurality of thin-film transistors and a second upper plate having transparent electrodes. A cholesteric liquid crystal layer is formed between the second lower plate and the second upper plate.

The present invention further provides a method for showing images on a flat-panel display after the flat-panel display is turned off. The flat-panel display includes a dual-panel display panel having a first display panel and a second display panel formed on top of the first display panel, wherein the second display panel has a cholesteric liquid crystal layer. The method comprises the following steps: obtaining and saving the image displayed on the first display panel according to a user's instruction, and then obtaining and displaying one of the saved images on the second display panel.

According to the present invention, the first display panel and the second display panel could have the same resolution.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is a perspective view of a dual-panel display panel according to an embodiment of the present invention.

FIG. 2 is a cross-sectional view of a flat-panel display comprising the dual-panel display panel shown in FIG. 1 according to the first embodiment of the present invention.

FIG. 3 is a cross-sectional view a flat-panel display comprising the dual-panel display panel shown in FIG. 1 according to the second embodiment of the present invention.

FIG. 4 is a flow chart illustrating a method for showing images after a flat-panel display according to an embodiment of the present invention is turned off.

### DETAILED DESCRIPTION OF THE INVENTION

The flat-panel display commonly used at present usually includes only one display panel for showing videos or images. The display panel may be of various types, such as TFT-LCD (Thin Film Transistor Liquid Crystal Display), PDP (Plasma Display Panel), Light Emitting Diode Display, ELD (Electro-Luminescence Display), or FED (Field Emission Display).

The idea of the present invention is to provide another TFT-LCD panel as a second display panel on top of the first display panel that shows videos or images, to thereby form a dual-panel display panel or a more advanced flat-panel display.

The second TFT-LCD panel uses cholesteric liquid crystals as the crystal material, which is bistable (power-saving) and has 360-degree visibility. The second display panel has a second control circuit (not shown in the drawing) separated from the first display panel. When a user uses the flat-panel display showing videos or images, the cholesteric liquid crystal layer (not shown in the drawing) may be set to the open status to thereby not affect the display of the first display panel. Before turning off the TV, the user may pre-select an image and save it, and display the image on the second display panel by controlling the second control circuit. By means of this configuration, the flat-panel display of the present invention may still display pictures or images even after it is turned off.

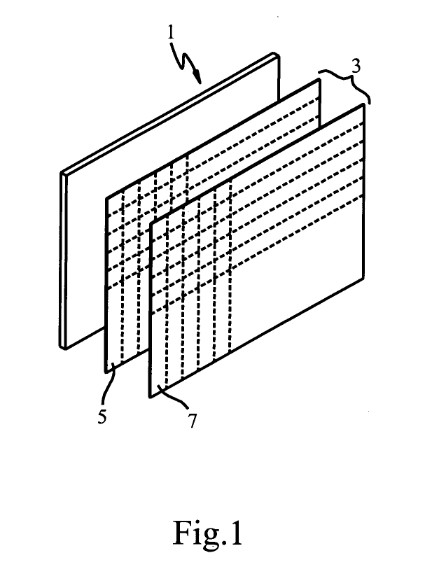

FIG. 1 is a perspective view of a dual-panel display panel according to an embodiment of the present invention.

For simplicity, the figure only shows the first display panel 1, and a second display panel 3 formed on the first display panel 3. The second display panel 3 includes the second lower plate 5 and the second upper plate 7, with a liquid crystal layer 9 between them. The liquid crystal layer 9 may be made from cholesteric liquid crystals.

As stated above, at present there are many different types of display panels, which cannot be described one by one here. In exemplary embodiments of the present invention, a second display panel including a cholesteric liquid crystal layer may be combined with a first display panel, such as the commonly used LCD or PDP, to form a dual-panel display panel or a more advanced flat-panel display. Although exemplary embodiments of the present invention only use LCD or PLD as an example for the first display panel, the exemplary embodiment should meet the requirements for the best mode during examination and enforcement.

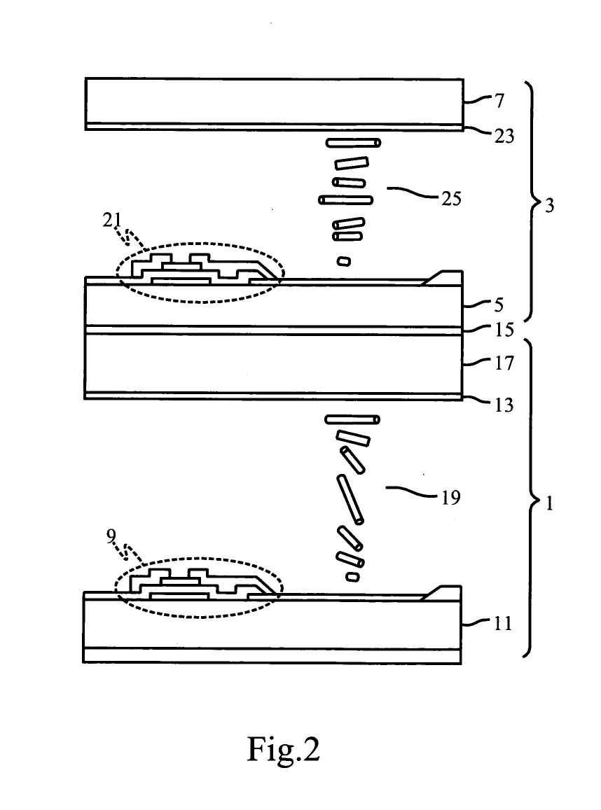

FIG. 2 is a cross-sectional view of a flat-panel display comprising the dual-panel display panel shown in FIG. 1 according to the first embodiment of the present invention.

As shown in FIG. 2, an exemplary embodiment of the present invention includes a first display panel 1, which is an LCD display, and a second display panel 3. The first display panel includes a first lower plate 11 having thin-film transistors 9, and a second upper plate 17 having transparent electrodes 13 and a polarizing plate 15. A liquid crystal layer 19 lies between the first upper plate 17 and the first lower plate 11.

The second display panel 3 formed on the first display panel 1 is a liquid crystal display panel, which includes the second lower plate 5 having thin-film transistors 21, and the second upper plate 7 having transparent electrodes 23. The second lower plate 5 is connected to the first display panel 1. A liquid crystal layer 25 lies between the second upper plate 7 and the second lower plate 5. The crystal layer 25 is made from cholesteric liquid crystals.

The first display panel 1 and the second display panel 3 have corresponding first control circuit and second control circuit respectively (not shown in the drawings).

The integration of the cholesteric liquid crystal layer 25 and the first display panel 1 requires that their resolutions match, so that the thin-film transistor 21 of the second lower plate 5 and the thin-film transistor 9 of the first lower plate correspond to each other.

When the resolutions of the first display panel and the second display panel do not match, the image produced through the first display panel 1 and the corresponding control circuit needs to be converted to comply with the resolution of the second display panel 3. The conversion may be performed by a converting device or a software program.

Further, the first upper plate 17, the second lower plate 5 and the second upper plate 7 are all transparent in order for the first display panel 1 and the second display panel 3 to show the images.

A main controller (not shown in the drawings) is provided according to exemplary embodiments of the present invention. The main controller connects to a first control circuit (not shown in the drawings) and a second control circuit (not shown in the drawings) or is combined with the two circuits to form one single circuit. When the first display panel is turned on, the main controller controls the second control circuit (not shown in the drawings) to adjust the cholesteric liquid crystal layer to open status to let light pass through, and enables the user to select an image from the images shown on the first display panel or saved in a memory device for display on the second display panel.

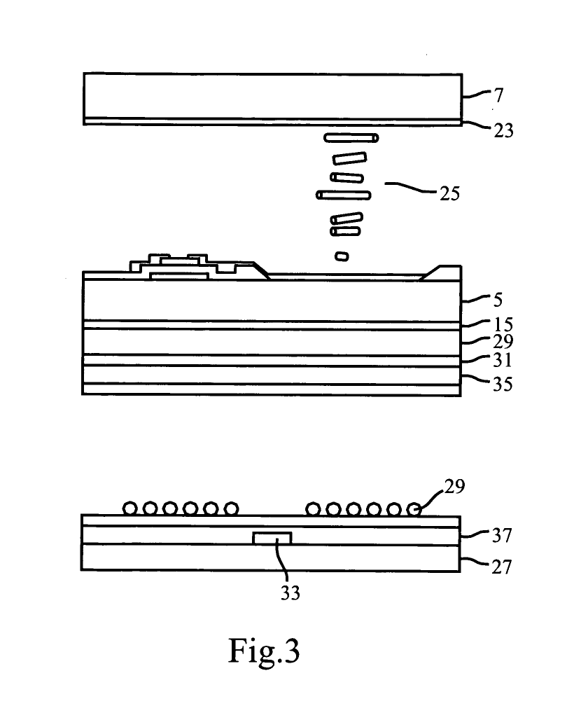

FIG. 3 is a cross-sectional view a flat-panel display comprising the dual-panel display panel shown in FIG. 1 according to the second embodiment of the present invention.

As shown in FIG. 3, another exemplary embodiment of the present invention includes a first display panel 1, which is DC type PDP, and a second display panel 3. The first display panel 1 includes a first lower plate 27 and a first upper plate 29. The electrode 31 on the upper plate 29 and the electrode 33 on the first lower plate 27 are arranged in a crisscross pattern. The first upper plate 29 has dielectrics 35, and the first lower plate 27 has dielectrics 37. The dielectrics 37 on the first lower plate 27 further have a fluorescent material thereon.

Similarly, the second display panel 3 formed on the first display panel 1 is a liquid crystal display panel, including a second lower plate 5 having thin-film transistors 21 and the second upper plate 7 having transparent electrodes 23. The second lower plate 5 is adjacent and connected to the first display panel 1. Between the second upper plate 7 and the second lower plate 5 is a liquid crystal layer 25, which is made from cholesteric liquid crystals.

Further, the first display panel 1 and the second display panel 3 have corresponding first control circuit and second control circuit respectively (not shown in drawings). A main controller (not shown in drawings) may be connected to the first control circuit and the second control circuit or be combined with them to form a single circuit. When the first display panel 1 is turned on, the main controller controls the second control circuit to adjust the cholesteric liquid crystal layer 25 of the second display panel 3 to the open status to let light pass through, and enables the user to select an image from the images shown on the first display panel or saved in a memory device for display on the second display panel 3.

The resolutions of the cholesteric liquid crystal layer 25 and the first display panel 1 need to match so that the thin-film transistors 21 of the second lower plate 5 correspond to the X-Y crossly arranged electrodes 31 and 33 of the first upper plate 29 and the first lower plate 27 respectively. When the resolutions of the first display panel 1 and the second display panel 3 do not match, a converter may be used to adjust the resolution of the image produced from the first display panel 1 and the corresponding control circuit in order to match the resolution of the second display panel 3.

If the thin-film transistors of the flat-panel display cause electromagnetic interference, the thin-film transistors of the cholesteric liquid crystal layer must be reversely adjusted.

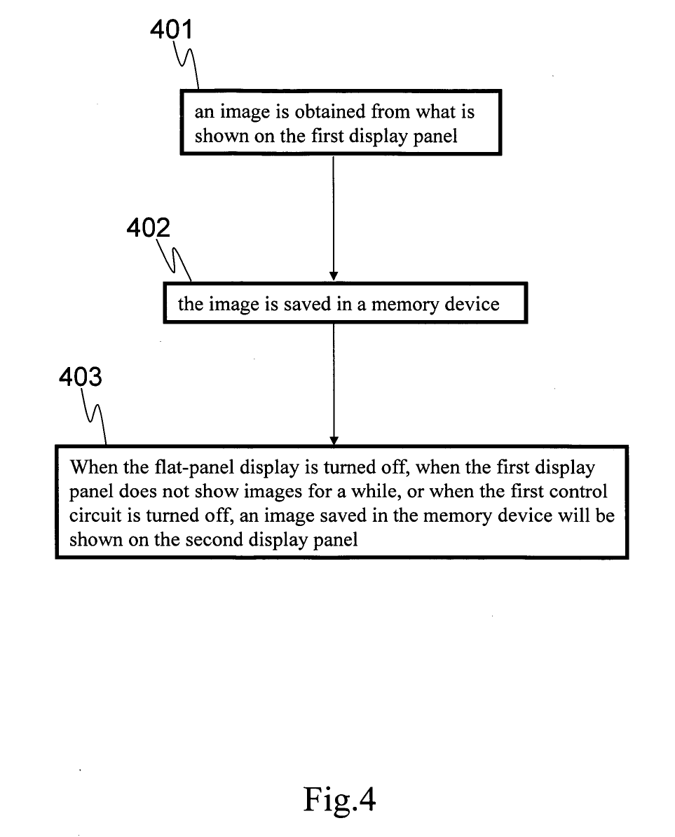

Next, a method for showing images after the flat-panel display of the embodiment is turned off is described. A flowchart of FIG. 4 shows the method for showing image after the flat-panel display shown in FIG. 2 is turned off. First, when the flat-panel display shown in FIG. 2 is in use, during which the second control circuit is turned off and the cholesteric liquid crystal layer is at the open status, an image is obtained from the first display panel 1. The source of the images may be a card reader, a general media (such as a TV set and/or a DVD/VCD player), or a digital camera (Step 401). Then, the image is saved in a memory device, which may be installed either within or outside of the flat-panel display (Step 402). When the flat-panel display is turned off, when the first display panel 1 does not show images for a while, or when the first control circuit is turned off, an image saved in the memory device will be shown on the second display panel 3 (Step 403). When no power is provided, the image will still show on the flat-panel display because of the bistable characteristic of cholesteric liquid crystals.

The images saved in the memory device may be an image obtained from the images shown on the flat-panel display, or an image obtained from a image memory device. The image memory device may be a walkman, SD card or other device for saving pictures or images.

From the description above, when the flat-panel display is in use, the thin-film transistors of the cholesteric liquid crystals will be turned off, thus cholesteric liquid crystal layer is on the open status. Because the cholesteric liquid crystals are characterized by 360-degree visibility, the normal function of the flat-panel display will not be affected. Further, when the flat-panel display is turned off or when the first display panel does not show images for a while, the main controller may control the second display panel to show an image saved in the memory device. Because of the bistable characteristic of cholesteric liquid crystals, when power is not provided, the image selected will be still show on the display panel. The image may be pre-selected or selected randomly.

As described above, the flat-panel display according to the exemplary embodiments of the present invention can become a beautiful picture instead of a dark and dull scene after the flat-panel display is turned off.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A dual-panel display panel, comprising:
a first display panel; and
a second display panel located on the first display panel;
wherein the second display panel includes: a second lower plate having a plurality of thin film transistor and a second upper plate; and a cholesteric liquid crystals layer formed between the second lower plate and the second upper plate.

2. The dual-panel display panel of claim 1, further comprising a main controller for controlling the cholesteric liquid crystal layer to an open status when the first display panel starts.

3. The dual-panel display panel of claim 1, further comprising a main controller for obtaining an image from the first display panel and saving the image.

4. The dual-panel display panel of claim 3, wherein the main controller controls the second display panel to show a saved image when the first display panel is turned off.

5. The dual-panel display panel of claim 1, wherein the second lower plate and the second upper plate are transparent.

6. The dual-panel display panel of claim 1, wherein the first display panel is a liquid crystal display panel.

7. The dual-panel display panel of claim 1, wherein the first display panel is a plasma display panel.

8. The dual-panel display panel of claim 1, wherein the first display panel and the second display panel have the same resolution.

9. A flat-panel display, comprising a dual-panel display panel according to claim 1.

10. A method for showing images on a flat-panel display after the flat-panel display is turned off, wherein the flat-panel display includes a dual-panel display panel having a first display panel and a second display panel, the second display panel being located on the first display panel and having a cholesteric liquid crystal layer, the method comprising:
obtaining images from the first display panel and saving the images when the first display panel is on; and
obtaining an image from the saved images and showing the image through the second display panel.

11. The method of claim 10 for showing images on a flat-panel display after the flat-panel display is turned off, wherein the first display panel and the second display panel have the same resolution.

12. A method for showing images on a flat-panel after the flat-panel display is turned off, wherein the flat-panel display includes a dual-panel display panel having a first display panel and a second display panel, the second display panel having a cholesteric liquid crystal layer and the second display panel being located on the first display panel, the method comprising:
setting the cholesteric liquid crystal layer to an open status when the first display panel is showing images;
turning on the second display panel to show an image once shown on the first display panel when the first display panel does not show images; and
turning off the flat-panel display.

13. The method of claim 12 for showing images on a flat-panel display after the flat-panel display is turned off, wherein the first display panel and the second display panel have the same resolution.
